(19) United States
(12) Patent Application Publication
(10) Pub. No.: US 2007/0203767 A1
(43) Pub. Date: Aug. 30, 2007

(54) Apparatus and method for indexing data changes

(75) Inventors: John Malcolm MacGregor, Ascot (GB); Robert Patrick Case, Warwick (GB)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/364,565

(22) Filed: Feb. 27, 2006

(51) Int. Cl. G06F 17/50

(52) U.S. Cl. 705/7

(57) ABSTRACT

A computer-readable medium to direct a computer to function in a specified manner includes executable instructions to: create a data table characterizing data values; standardize changes between data values to produce standardized values; and apply a weighting factor to the standardized values to produce a data change index.

### BRIEF DESCRIPTION OF THE INVENTION

The present invention relates generally to data processing. More particularly, the present invention relates to a technique for accurately characterizing the variance in a collection of data values.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

The present invention relates to the analytical and reporting aspects of BI. Analyzing the effect that business records have on an enterprise has become increasingly more valuable and complex. A business record or business data value is a measure of the performance of an enterprise (e.g., commercial, governmental, non-profit, etc.). The business data value may be financial, human resource, marketing, sales, customer or supplier information. While there are existing tools to analyze the variance of business records over time, these tools can offer an inaccurate reflection of the true variance that exists between various business records.

Therefore, it would be desirable to provide a new technique that reflects a more accurate measure of the variance associated with business records over time. In particular, it would be desirable to provide a method that accurately characterizes the variation of business data values to enable a correct assessment of which variances require the most attention.

### SUMMARY OF THE INVENTION

The invention includes a computer-readable medium to direct a computer to function in a specified manner. The computer-readable medium includes executable instructions to: create a data table characterizing data values; standardize changes between data values to produce standardized values; and apply a weighting factor to the standardized values to produce a data change index.

The invention also includes a computer implemented method of processing data, comprising: creating data values; standardizing changes between data values to produce standardized values; and applying a weighting factor to the standardized values to produce data variance values.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a computer that may be operated in accordance with an embodiment of the invention.

FIG. 2 illustrates processing operations performed in accordance with an embodiment of the invention.

FIG. 3 illustrates an exemplary data table that may be presented in accordance with an embodiment of the invention.

FIG. 4 illustrates an exemplary data table with actual and percent changes that may be presented in accordance with an embodiment of the invention.

FIG. 5 illustrates an exemplary data table with standardized percent and actual changes that may be presented in accordance with an embodiment of the invention.

FIG. 6 illustrates an exemplary data table with weighting and data changes indices that may be presented in accordance with an embodiment of the invention.

### DETAILED DESCRIPTION OF THE INVENTION

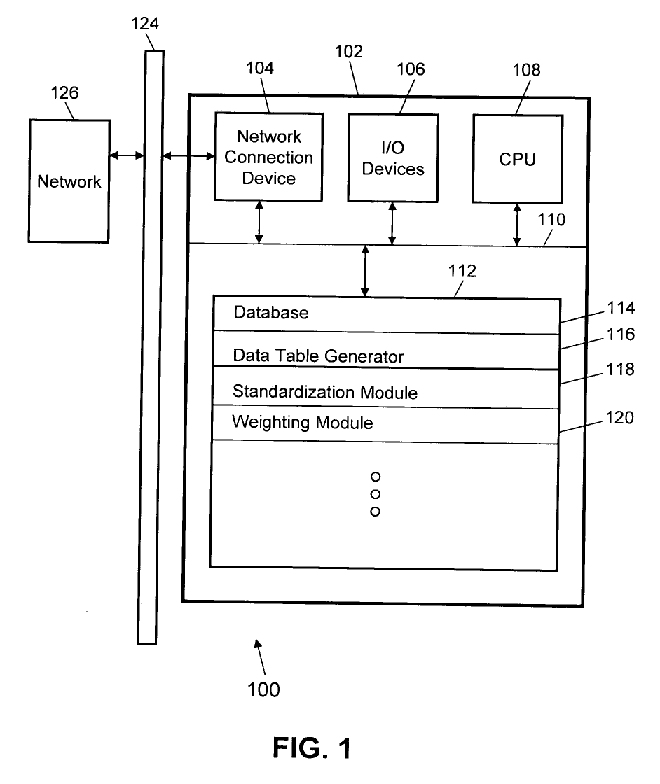

FIG. 1 illustrates a computer network 100 that may be operated in accordance with an embodiment of the invention. The computer network 100 includes a computer 102, which, in general, may be a client computer or a server computer. In the present embodiment of the invention, the computer 102 is a server computer including conventional server computer components. As shown in FIG. 1, the computer 102 includes a Central Processing Unit (“CPU”) 108 that is connected to a network connection device 104 and a set of input/output devices 106 (e.g., a keyboard, a mouse, a display, a printer, a speaker, and so forth) via a bus 110. The network connection device 104 is connected to network 126 through the network transport medium 124, which may be any wired or wireless transport medium.

The CPU 108 is also connected to a memory 112 via the bus 110. The memory 112 stores a set of executable programs. One executable program is the data table generator 116. The data table generator 116 includes executable instructions to access a data source to produce a data table comprising various business records. By way of example, the data source may be database 114 resident in memory 112. The data source may be located anywhere in the network 126. A data table is an instrument that may be used by an enterprise to present recorded business data values over time in relationship to other business records.

As shown in FIG. 1, the memory 112 also contains a standardization module 118. The standardization module 118 allows for an accurate representation of the change associated with business records by producing standardized actual and percent changes associated with recorded business data values. The standardization module 118 includes executable instructions to access a data source to generate business data values. By way of example, the data source may be database 114 resident in memory 112. In one embodiment of the invention, the standardization module 118 standardizes the actual and percent changes associated with the business records in the data table generated by the data table generator 116 to allow for an accurate representation of any variance in data.

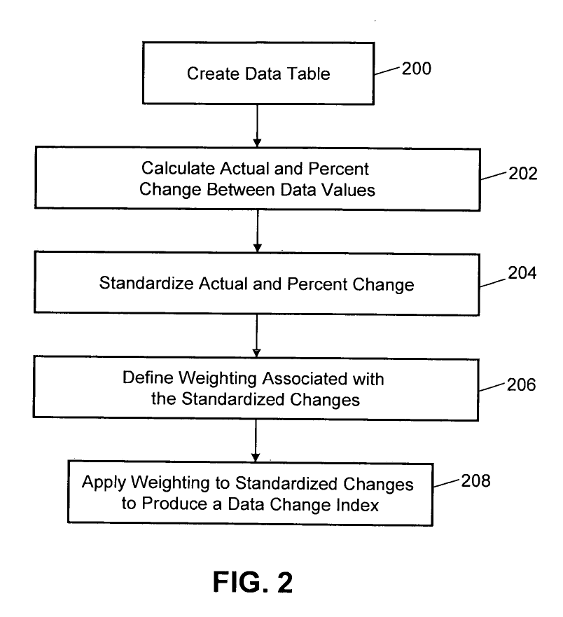

FIG. 1 also shows that the memory 112 contains a weighting module 120. The weighting module 120 applies a user defined weighting to the standardized percent and actual changes generated by the standardization module 118 to produce a data change index. A data change index is a variable that is a weighted reflection of the standardized percent and actual changes generated by the standardization module 118. The weighting module 120 includes executable instructions to access a data source to define the weighting associated with the standardized actual and percent changes. By way of example, the data source may be database 114 resident in memory 112. In one embodiment of the invention, a data change index is produced by the standardization module 118 and weighting module 120 according to the processing operations illustrated in FIG. 2.

While the various components of memory 112 are shown residing in the single computer 102, it should be recognized that such a configuration is not required in all applications. For instance, the standardization module 118 may reside in a separate computer (not shown in FIG. 1) that is connected to the network 126. Similarly, separate modules of executable code are not required. The invention is directed toward the operations disclosed herein. There are any number of ways and locations to implement those operations, all of which should be considered within the scope of the invention.

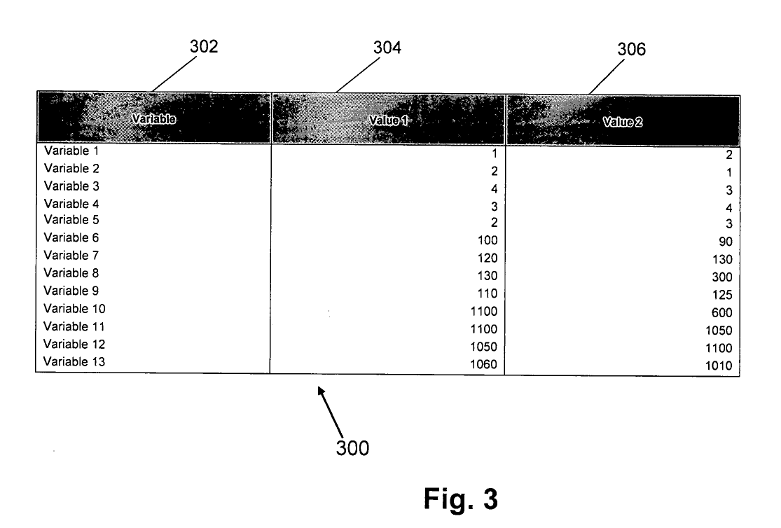

FIG. 2 illustrates processing operations associated with an embodiment of the invention. The first processing operation shown in FIG. 2 is to create a data table 200. In one embodiment of the invention, this is implemented with executable code of the data table generator 116. An example of a data table that may be generated is shown in FIG. 3. FIG. 3 illustrates a data table 300 that presents various business records for different variables 302, Variable 1-Variable 13, at two different periods, Value 1 304 and Value 2 306. The business data values may represent various business records or other events in a business. For instance, the business data values of data table 300 may represent the weekly sales figures for different products (Variable 1-Variable 13) offered by business over a two week period (Value 1 304 and Value 2 306). Accordingly, the data table 300 presents various business records in conjunction with other recorded business data values.

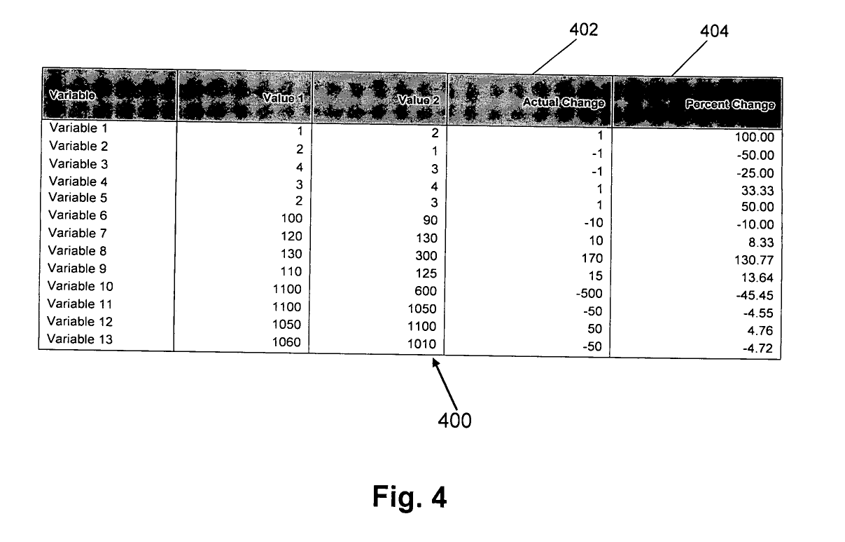

Returning to FIG. 2, the next processing operation is to calculate the actual and percent changes between business data values 202 presented in the data table generated by the data table generator 116. The standardization module 118 may calculate and present the actual and percent changes associated with the variance between business data values of a data table. For example, FIG. 4 illustrates a data table 400 that presents the actual changes 402 and percent changes 404 for the business records presented in data table 300. Accordingly, data table 400 enables a business the ability to analyze which business records have had the most variance, in terms of either actual or percent change. Previous tools have used either actual or percent changes to determine which variances need to be highlighted for further investigation. However, using actual or percent changes alone can be grossly inaccurate and ultimately a poor method to determine which variable data change requires the most attention. For instance, traditional variance analysis using only actual change would identify “Variable 10” in data table 300 as having the highest variance while many other variables had much higher percent changes. Similarly, traditional variance analysis using only percent change would identify “Variable 8” in data table 300 as having the highest variance while another variable has a greater actual change. Thus, traditional data variance analysis provides an inaccurate method to identify the true variance associated with business records.

Returning to FIG. 2, the next processing operation is to standardize the actual and percent changes 204 associated with the variance in business records presented in the data table generated by the data table generator 116. The standardization module 118 may use the previously calculated actual and percent changes to generate standardized actual and percent changes associated with a collection of business records. The standardization module 118 may first compute the mean and standard deviation associated with the previously calculated actual changes in the collection of business records. The standard deviation of the actual changes for the same collection of business records is then computed. The standard deviation calculation may use N as the denominator or may use N−1 as the denominator, where N is the number of data values being used in the calculation. When N is used this is sometimes referred to as the population standard deviation, the N method, and /or the biased standard deviation. When N−1 is used this is sometimes referred to as the sample standard deviation, the N−1 method, and/or the unbiased standard deviation. While the present example uses the N method, either method could be used. The standardization module 118 may then use the mean of the group, the standard deviation of the group, and the specific actual change of each variable to generate a standardized actual change for every variable according to the following formula:
Standardized Actual Change=(Actual Change−Mean Actual Change)/Standard Deviation of Actual Changes.
Similarly, the standardization module 118 may use an equivalent process to generate a standardized percent change according the following formula:
Standardized Percent Change=(Percent Change−Mean Percent Change)/Standard Deviation of Percent Changes

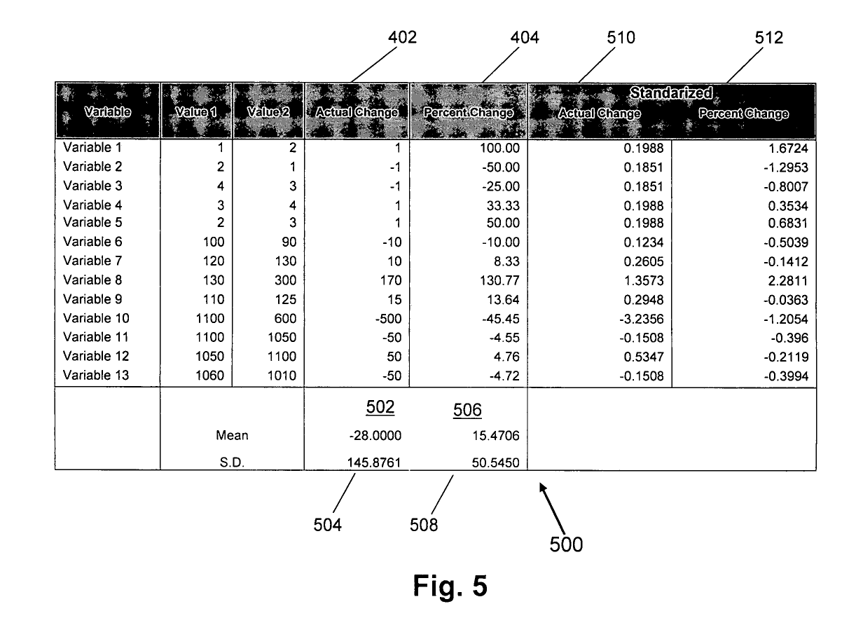

For example, FIG. 5 presents a data table 500 with the standardized actual and percent changes associated with the collection of business records of data table 400. As shown in FIG. 4, the actual mean 502 and actual standard deviation 504 for the collection of actual changes 402 is presented underneath its respective column. Correspondingly, the percent mean 506 and percent standard deviation 508 for the group of percent changes 404 is presented below its respective column. The standardization module 118 then uses these computations to generate the standardized actual changes 510 and standardized percent changes 512 of data table 500.

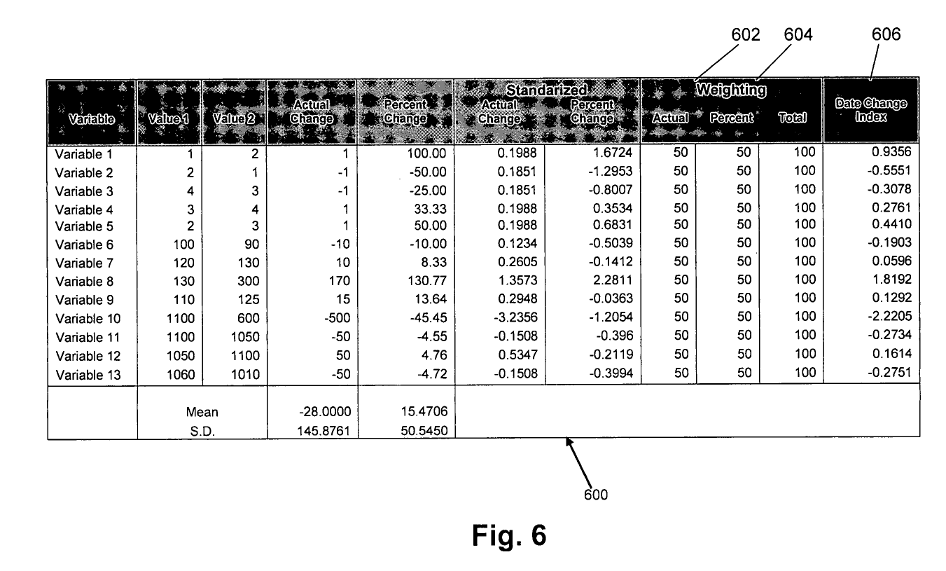

Returning to FIG. 2, the next processing operation is to define the weighting associated with the standardized changes 206 to be applied to the standardized changes generated by the standardization module 118. In one embodiment of the invention, the user may specify a percent weighting to apply to the standardized actual and percent changes to ultimately generate a data change index. For instance, FIG. 6 illustrates a weighting that may be applied to the standardized changes of the data table 500. In this example, an equal actual weighting 602 and percent weighting 604 will be applied to the standardized actual changes 510 and standardized percent changes 512 for every variable of data table 500. Alternatively, the user may define an unequal weighting to the standardized changes if more importance is to be given to either the actual or percent change. Additionally, individual weightings may be applied to different variables in the data table as desired by the user

As shown in FIG. 2, the last processing operation is to apply the weightings to the standardized changes to generate a data change index 208. The weighting module 120 may apply the defined weightings to the standardized actual and percent changes produced by the standardization module 118 to generate a data change index. Each individual weighting is applied to the standardized actual change and standardized percent change, respectively, and summed together to ultimately produce a data change index. For example, FIG. 6 presents the resultant data change indexes 606 derived from applying an equal weighting to the standardized changes of data table 500. Thus, the data change index is a weighted representation of the standardized actual and percent changes associated with the variance between business records.

Ultimately, the data change index grants a business the ability to accurately characterize the variance between business records to determine which variances require the most attention. For example, whereas traditional variance analysis using percent change alone would have identified Variable 8 of data table 300 as possessing the greatest variance, the data change index indicates that Variable 10 had the greatest change. The data change index offers a business a much more accurate representation of variance by utilizing weighted standardized forms of the actual and percent changes associated with a collection of business data values. The firm now has an accurate means of determining which variances require the greatest attention.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt to a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A computer-readable medium to direct a computer to function in a specified manner, comprising executable instructions to:
create a data table characterizing data values;
standardize changes between data values to produce standardized values; and
apply a weighting factor to the standardized values to produce a data change index.

2. The computer-readable medium of claim 1, wherein the executable instructions to standardize include executable instructions to determine the actual and percent changes associated with the data values.

3. The computer-readable medium of claim 2, further comprising executable instructions to compute the mean and standard deviation of the actual and percent changes associated with the data values.

4. The computer-readable medium of claim 3, further comprising executable instructions to use the mean and standard deviation values to produce the standardized values.

5. The computer-readable medium of claim 3, further comprising executable instructions to use the mean and standard deviation values to produce standardized percent change values.

6. The computer-readable medium of claim 1, wherein the executable instructions to apply a weighting factor include executable instructions to receive a user defined weighting factor.

7. A computer implemented method of processing data, comprising:
creating data values;
standardizing changes between data values to produce standardized values; and
applying a weighting factor to the standardized values to produce data variance values.

8. The method of claim 7, wherein standardizing changes includes determining the actual and percent changes associated with the data values.

9. The method of claim 8, wherein determining the actual and percent changes includes determining the mean and standard deviation of the actual and percent changes associated with the data values.

10. The method of claim 9, further comprising using the mean and standard deviation values to produce the standardized values.

11. The method of claim 9, further comprising using the mean and standard deviation values to produce standardized percent change values.

12. The method of claim 7, wherein applying a weighting factor includes receiving a user defined weighting factor.
